(19) United States
(12) Patent Application Publication
(10) Pub. No.: US 2004/0227606 A1
(43) Pub. Date: Nov. 18, 2004

(54) Stacked cores and the heat dissipation method for the same

(75) Inventors: Yi-Min Lin, Taipei (TW); San-Juang Haung, Taipei (TW)

Correspondence Address: BACON & THOMAS, PLLC, 625 SLATERS LANE, FOURTH FLOOR, ALEXANDRIA, VA, 22314

(73) Assignee: PHOENIXTEC POWER CO. , LTD., Taipei (TW)

(21) Appl. No.: 10/419,938

(22) Filed: Apr. 22, 2003

(51) Int. Cl. H01F 27/08; F28F 7/00

(52) U.S. Cl. 336/61; 336/55; 336/60

(57) ABSTRACT

A configuration of stacked cores and the heat dissipation for the stacked cores utilize a plurality of spacers provided between adjacent cores, whereby a gap is accordingly formed by the spacers to expedite the heat dissipation. Since a gap is defined between the adjacent cores, the heat dissipation surfaces for adjacent cores are increased and the generated heat is quickly removed from the stacked cores in a short time.

### BACKGROUND OF THE INVENTION

1. Field of Invention

The present invention relates to stacked cores and a heat dissipation method for the stacked cores, and more particularly to a heat dissipation technique that is able to increase the heat dissipation surface of the stacked cores to obtain superior efficiency of heat dissipation.

2. Related Art

In the present techniques, cores are widely applied to construct transformers or inductors etc. Occasionally, a large size core is necessary to meet some particular requirements, for example the core is used for high power circuit design. However, such a large size core may be difficult to obtain. Further, if such a particular large size core is designed and manufactured specially, it would cause a high increase in the fabricating cost. Therefore, some well known solution manners are to stack up plural cores together as a single unit, or to connect multiple magnetic elements, formed by a single core, in parallel.

With reference to FIG. 11, two cores (50a)(50b) are stacked with each other and then multiple windings (60) are provided to twist around the two stacked cores (50a)(50b). No doubt, such a stacked arrangement meets the circuit design requirements. However, the stacking of the cores (50a)(50b) causes a serious problem of bad heat dissipation. As shown in the drawing, each core (50a)(50b) has a surface that completely contacts with the other, and the windings (60) are twisted around the two cores (50a)(50b) densely. Thus, once a current is provided to and flows through the windings (60), the temperature of the cores (50a)(50b) rises quickly in a short period. Furthermore, because the cores (50a)(50b) are twisted by the windings (60) densely, it is hard to dissipate the heat energy in a short time. With the increase in the amount of the stacked cores, the heat dissipation is a serious problem that needs to be solved.

The stacked cores and the heat-dissipation method for the stacked cores in accordance with the present invention obviate or mitigate the aforementioned drawbacks.

### SUMMARY OF THE INVENTION

The main objective of the present invention is to provide stacked cores and a heat dissipation method for the stacked cores, wherein the method increases the heat dissipation surface of the stacked cores to improve the efficiency of heat dissipation.

To achieve the objective, when multiple cores are intended to be stacked up, spacers are applied to butt between adjacent cores, whereby a gap is defined between the adjacent cores to expedite the heat dissipation.

Further, the heat dissipation method is widely applied to all kinds of cores. Even when the stacked cores are manufactured with different materials, the present invention still provides superior effect.

Other objectives, advantages and novel features of the invention will become more apparent from the following detailed description when taken in conjunction with the accompanying drawings.

### BRIEF DESCRIPTION OF THE DRAWINGS

FIGS. 1 and 2 show a first embodiment of two stacked cores in accordance with the present invention;

FIGS. 3 and 4 show the stacked cores of FIG. 1 are twisted with windings;

FIGS. 5 and 6 show a second embodiment of two stacked cores in accordance with the present invention;

FIGS. 7 and 8 show a third embodiment of two stacked cores in accordance with the present invention;

FIG. 9 shows the temperature test data of the stacked cores in accordance with the present invention;

FIG. 10 shows the temperature test data of the conventional stacked cores; and

FIG. 11 is perspective view showing two cores are overlapped in a conventional manner.

### DETAILED DESCRIPTION OF THE INVENTION

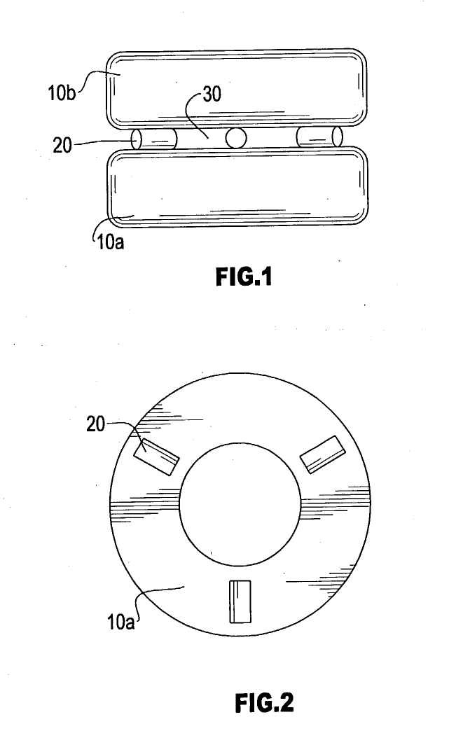

With reference to FIGS. 1 and 2, a first embodiment of the present invention includes two cores (10a)(10b) that are stacked with each other. A gap (30) is defined between the two cores (lOa)(lOb) to expedite the heat dissipation, wherein the gap (30) may be defined by the multiple spacers (20) provided between the two cores (10a)(10b) as shown in the drawings, or by protrusions (not shown) that are formed on surfaces of the cores (10a)(10b). The spacers (20) can be applied on a surface of any cores (10a)(10b), wherein the spacers (20) are mounted on the top surface of the core (10a) in the embodiment.

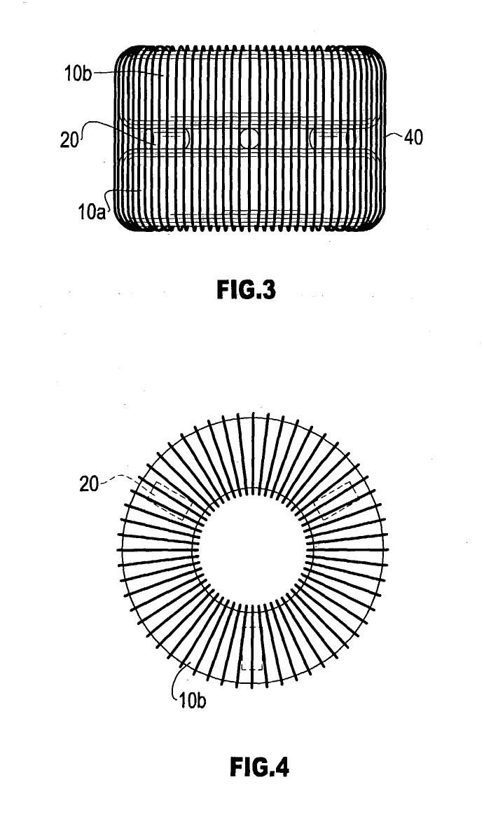

With reference to FIGS. 3 and 4, after the cores (10a)(10b) are stacked and the spacers (20) are applied between the two cores (10a)(10b), multiple windings (40) are twisted around the two cores (10a)(10b). When a current flows through the windings (40), the generated heat is able to be removed quickly because the two cores (10a)(10b) are not directly contacted with each other. In other words, the heat dissipation surfaces are increased, i.e. the top surface of the core (10a) and the bottom surface of the core (10b) are now exposed, so the heat dispersal is further enhanced.

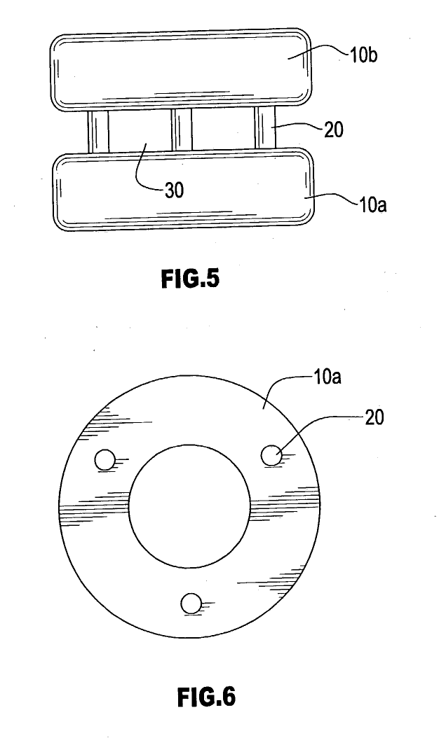

With reference to FIGS. 5 and 6, the second embodiment is substantially the same as the first one. The spacers (20) in the first embodiment (shown in FIGS. 1 and 2) are formed as cylinders and are horizontally distributed between the two cores (10a)(10b). In the second embodiment, these spacers (20) are perpendicularly provided between the cores (10a)(10b) to enlarge the gap (30).

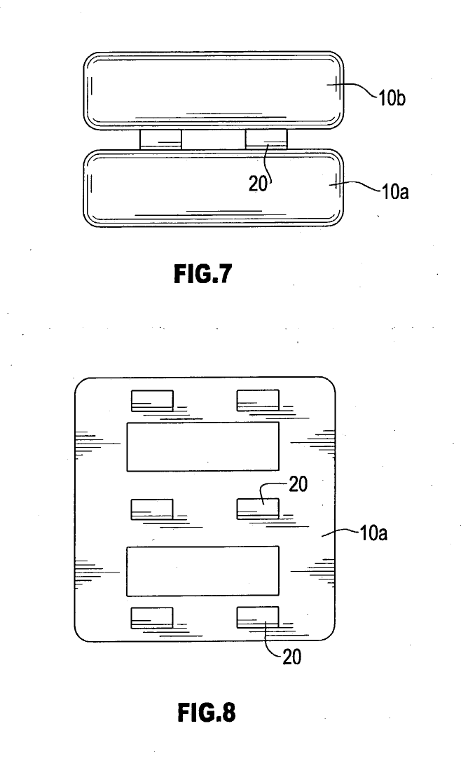

With reference to FIGS. 7 and 8, the heat dissipation manner of the present invention has no material or specification limitations in the cores (10a)(10b). The spacers are equally distributed between the two cores (10a)(10b) in the third embodiment to define the gap (30). Furthermore, the quantity of the stacked cores (10a)(10b) is not limited, either. The present invention is able to apply to multiple stacked cores (more than two).

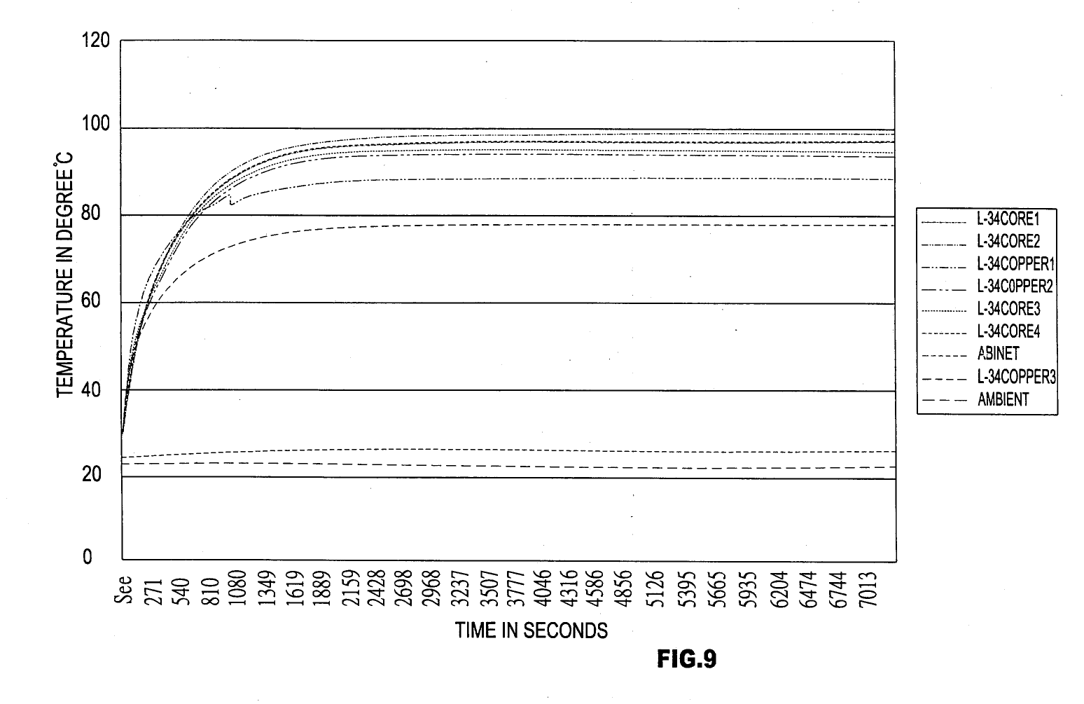

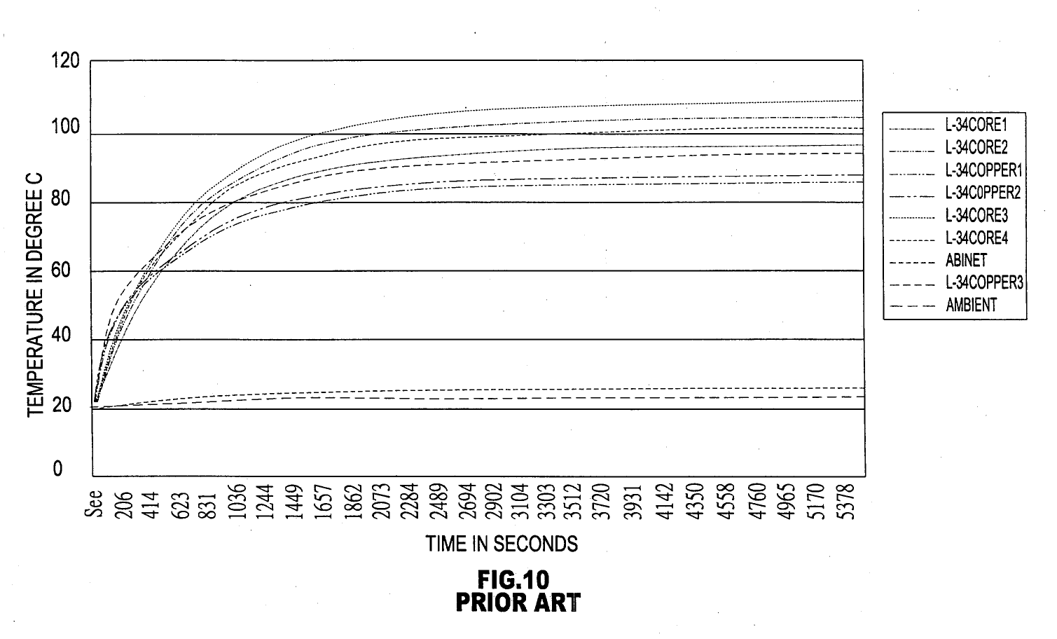

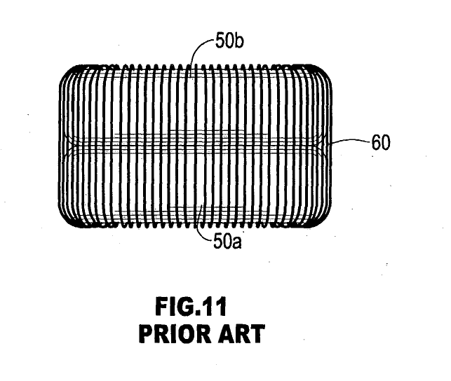

To prove the stacked cores of the present invention being advanced over the conventional configuration (as shown in FIG. 11), the temperature testing data of the present invention is illustrated in FIG. 9 and the testing data of conventional manner is in FIG. 10, wherein the specifications of the tested cores are identical. As shown in FIG. 9, the temperature of the conventional configuration is about 109 degrees Centigrade. However, the temperature is lowered and does not exceed 100 degrees Centigrade when the present invention is applied to the stacked cores.

The invention may be varied in many ways by a skilled person in the art. Such variations are not to be regarded as a departure from the spirit and scope of the invention, and all such modifications are intended to be included within the scope of the following claims.

What is claimed is:

1. A heat dissipation method for stacked cores, the method comprising:
stacking multiple cores up; and
forming a gap between each adjacent cores, whereby the adjacent cores do not directly contact with other, and heat dissipation surfaces of the adjacent cores are increased.

2. The method as claimed in claim 1, wherein the gap is formed by spacers that are provided between adjacent cores.

3. The method as claimed in claim 1, wherein the gap is formed by protrusions that are formed on a surface of any cores.

4. A configuration of stacked cores, the configuration comprising multiple cores that are stacked up and twisted with windings, wherein the improvement comprises:
a plurality of spacers provided between adjacent cores so as to form a gap between the adjacent cores to expedite heat dissipation when the windings are provided with a current.

5. The configuration of the stacked cores as claimed in claim 4, wherein the plurality of spacers is equally distributed between the adjacent cores.

6. The configuration of the stacked cores as claimed in claim 4, wherein each spacer is a cylinder shape.
